(19) United States
(12) Patent Application Publication
(10) Pub. No.: US 2015/0186462 A1
(43) Pub. Date: Jul. 2, 2015

(54) OPTIMIZING QUERY PROCESSING BY INTERPOSING GENERATED MACHINE CODE

(71) Applicant: International Business Machines Corporation, Armonk, NY (US)

(72) Inventors: CHRISTOPHER J. CRONE, San Jose, CA (US); Sarbinder S. Kallar, San Jose, CA (US); Andrei F. Lurie, San Jose, CA (US); Helen L. Tjho, San Jose, CA (US)

(73) Assignee: International Business Machines Corporation, Armonk, NY (US)

(21) Appl. No.: 14/146,180

(22) Filed: Jan. 2, 2014

(51) Int. Cl. G06F 17/30

(52) U.S. Cl. CPC G06F 17/30442; G06F 17/30595

(57) ABSTRACT

In an approach for optimizing query processing within a relational database management environment, one or more computer processors construct a first data structure for an access path operation. The first data structure is an interpretable data structure. The one or more computer processors determine whether the first data structure can be optimized with machine code. Responsive to determining the first data structure can be optimized with machine code, the one or more computer processors generate machine code to perform at least one operation of the first data structure.

### STATEMENT REGARDING PRIOR DISCLOSURES BY THE INVENTOR OR A JOINT INVENTOR

Various aspects of the present invention have been disclosed by an inventor or a joint inventor generally to the public in the product IBM DB2 11 for z/OS, made publically available on Oct. 25, 2013. This disclosure is submitted under 35. U.S.C. 102(b)(1)(A). The following documentation is provided in support:
IBM United States Software Announcement 213-376, dated Oct. 1, 2013, including IBM DB2 11 for z/OS: The database for data and analytics

### FIELD OF THE INVENTION

The present invention relates generally to the field of relational database management systems, and more particularly to optimizing query processing.

### BACKGROUND OF THE INVENTION

Relational Database Management System (RDBMS) software uses relational techniques for storing, processing, and retrieving data in a relational database. Relational databases are computerized information storage and retrieval systems. Relational databases are organized into tables that consist of rows and columns of data. The rows may be called tuples or records or rows. A database typically has many tables, and each table typically has multiple records and multiple columns. A RDBMS may use a Structured Query Language (SQL) interface.

When the RDBMS receives a query, the query specifies the data that the user wants, but not how to get to the data. When the query is received, during a prepare phase, the RDBMS converts the query into an executable form. Also during the prepare phase, the RDBMS determines access paths to the data to be retrieved by a query that describe how the data should be retrieved. The access path is the collection of steps that need to be carried out to process a given SQL statement. Each step in the access path represents a certain operation that needs to be performed, and these steps and operations are organized or connected in a specific order. Following the prepare phase, the RDBMS executes the query.

### SUMMARY

Embodiments of the present invention disclose a method, computer program product, and system for optimizing query processing within a relational database management environment. The method includes one or more computer processors constructing a first data structure for an access path operation. The first data structure is an interpretable data structure. The one or more computer processors determine whether the first data structure can be optimized with machine code. Responsive to determining the first data structure can be optimized with machine code, the one or more computer processors generate machine code to perform at least one operation of the first data structure.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a machine code generator, in a relational database management system within the data processing environment of FIG. 1, in accordance with an embodiment of the present invention.

FIG. 3 is a flowchart depicting operational steps of a runtime execution processor, in a relational database management system within the data processing environment of FIG. 1, in accordance with an embodiment of the present invention.

FIG. 4A is a depiction of an access path for an SQL statement example, in accordance with an embodiment of the present invention.

FIG. 4B is a depiction of an access path for an SQL statement example that utilizes a generated code processor, in accordance with an embodiment of the present invention.

FIG. 5 depicts a block diagram of components of the server computer of FIG. 1 that contains the relational database management system, in accordance with an embodiment of the present invention.

### DETAILED DESCRIPTION

In a typical relational database management system (RDBMS), a given Structured Query Language (SQL) query is represented by an access path which a runtime execution processor interprets at the time of query execution. One of the well-known approaches to improve interpretation cost is just-in-time compilation (JIT), and JIT-like techniques have been successfully applied to RDBMS query access path interpretation in the past. However, in a mature RDBMS, such techniques are typically difficult to introduce without significant development cost. The data structures that would have been generated before need to be replaced by machine code. This poses a design challenge of how to connect the machine code to the rest of the access path abstract data structures with minimal effort and minimal impact. Existing solutions typically either have strict boundaries at which the generated machine code can be mixed with the interpreted access path, or have been designed and implemented from the initial release of the product.

Embodiments of the present invention recognize that efficiency can be gained by implementing a flexible method of interposing compiled machine code with abstract data structures representing a query access path. Embodiments of the present invention recognize that efficiency may also be gained by maximizing the reuse of the existing code and data structures. Implementation of embodiments of the invention may take a variety of forms, and exemplary implementation details are discussed subsequently with reference to the Figures.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module” or “system”. Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java® (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

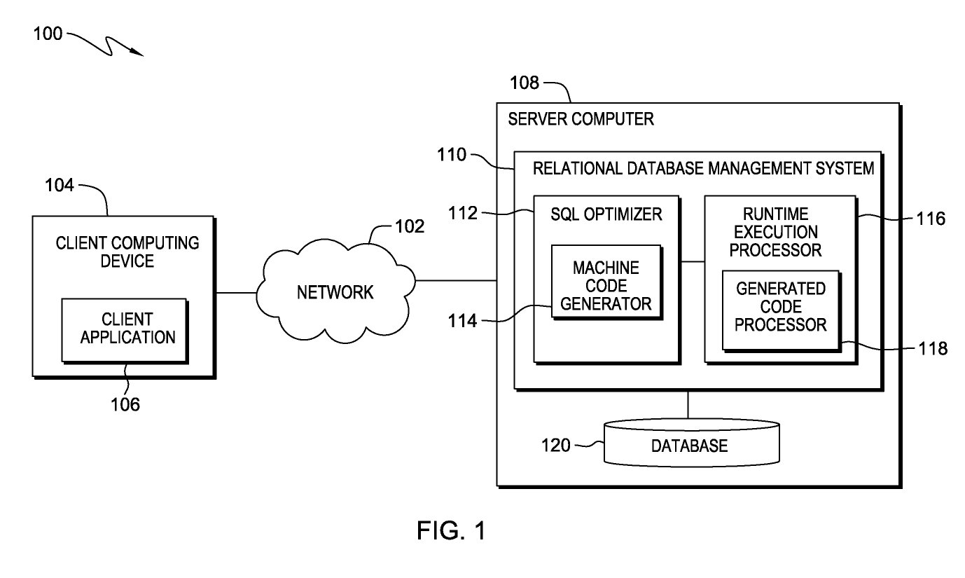

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 104 and server computer 108, all interconnected over network 102. Network 102 can be, for example, a local area network (LAN), a wide area network (WAN), such as the Internet, or a combination of the two, and can include wired, wireless, or fiber optic connections. In general, network 102 can be any combination of connections and protocols that will support communications between client computing device 104 and server computer 108.

Client computing device 104 may be a desktop computer, a laptop computer, a tablet computer, a specialized computer server, a smart phone, or any programmable electronic device capable of communicating with server computer 108 via network 102 and with various components and devices within distributed data processing environment 100. In general, client computing device 104 represents any programmable electronic device or combination of programmable electronic devices capable of executing machine-readable program instructions and communicating with other computing devices via a network, such as network 102. Client computing device 104 includes client application 106.

Client application 106 resides on client computing device 104. Client application 106 is any application or program that a user employs to submit a query to server computer 108. A query is a request for data stored in tables in a relational database management system (RDBMS). Queries allow the user to describe desired data, leaving the RDBMS responsible for planning, optimizing, and performing the physical operations necessary to produce that result. A query includes a list of columns to be included in the final result. Queries are typically written in Structured Query Language (SQL), a special-purpose programming language designed for managing data held in a RDBMS. SQL consists of a data definition language and a data manipulation language. The scope of SQL includes data insert, query, update and delete, schema creation and modification, and data access control.

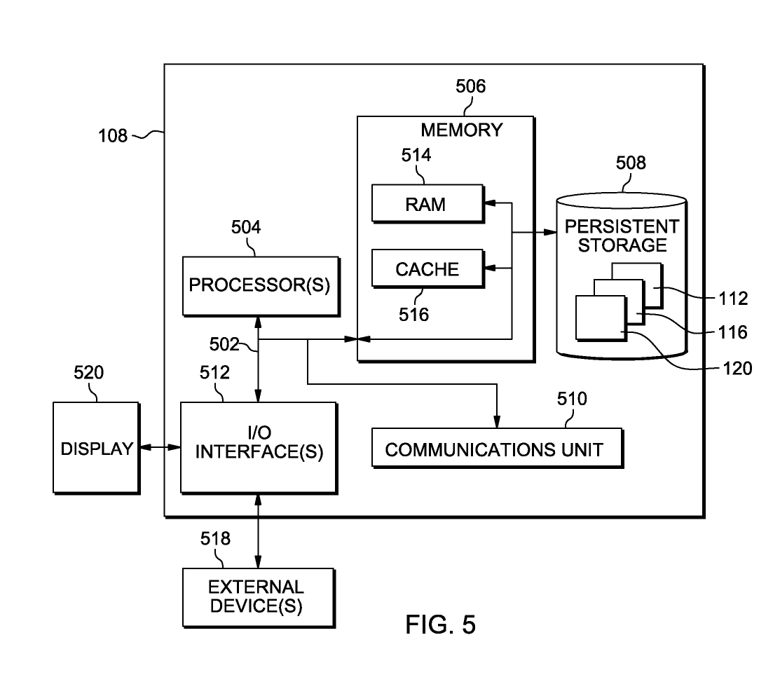

Server computer 108 may be a management server, a web server, or any other electronic device or computing system capable of receiving and sending data. In other embodiments, server computer 108 may represent a server computing system utilizing multiple computers as a server system, such as in a cloud computing environment. In another embodiment, server computer 108 may be a laptop computer, tablet computer, netbook computer, personal computer (PC), a desktop computer, a personal digital assistant (PDA), a smart phone, or any programmable electronic device capable of communicating with client computing device 104 via network 102. In another embodiment, server computer 108 represents a computing system utilizing clustered computers and components to act as a single pool of seamless resources. Server computer 108 includes relational database management system 110 and database 120. Server computer 108 may include internal and external hardware components, as depicted and described in further detail with respect to FIG. 5.

Relational database management system (RDBMS) 110 resides on server computer 108. A RDBMS is a program or group of programs that work in conjunction with the operating system to create, process, store, retrieve, control, and manage data. It acts as an interface between the application program and the data stored in a database. The objective of a RDBMS is to provide a convenient and effective method of defining, storing, and retrieving the information stored in the database. When the RDBMS receives a query, the query specifies the data that the user wants, but not how to get to that data. When the query is received, during a prepare phase, the RDBMS converts the query into an executable form. During a prepare phase, the RDBMS determines access paths to the data to be retrieved by a query that describe how the data should be retrieved. Then, the RDBMS executes the query.

RDBMS 110 includes SQL optimizer 112. Since SQL is a declarative language, there are typically a large number of alternative ways to execute a given query, with widely varying performance. When a user submits a query to the database, the SQL optimizer evaluates some of the different, correct possible plans for executing the query and returns what is considered to be the best alternative. Because SQL optimizers are imperfect, database users and administrators sometimes need to manually examine and tune the plans produced by the SQL optimizer to get better performance. Query performance of a database system is dependent not only on the database structure, but also on the way in which the query is optimized. Query optimization means converting a query into an equivalent form which is more efficient to execute.

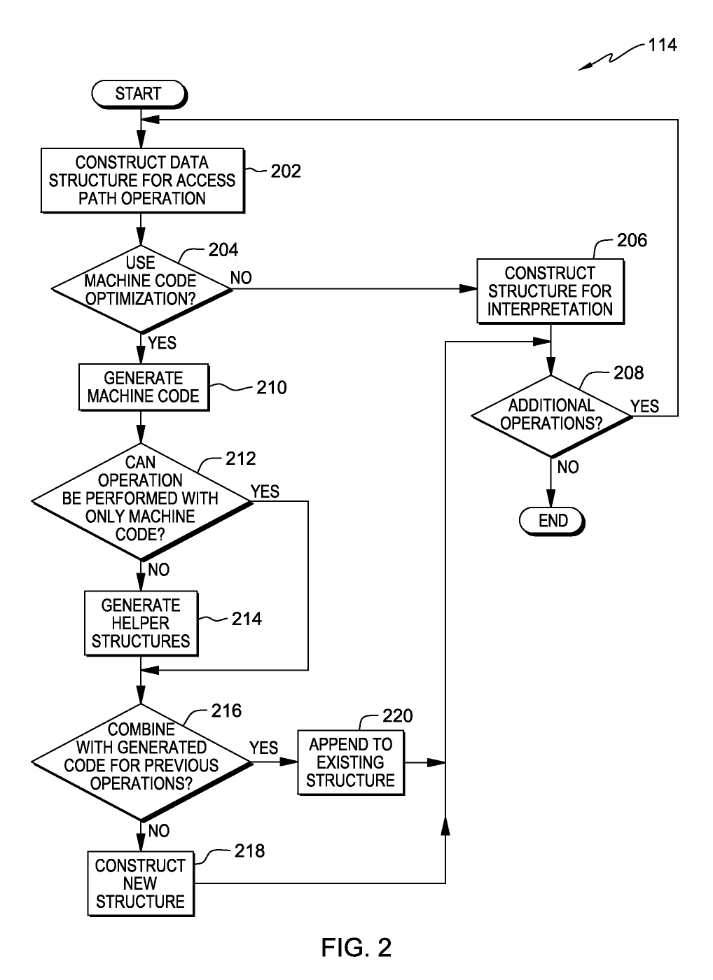

SQL optimizer 112 includes machine code generator 114. Machine code generator 114 constructs data structures for access path operations. The access path is the collection of steps that are carried out to process a given SQL statement. Each step in the access path represents a certain operation that is performed, and these steps/operations are organized or connected in a specific order. Machine code generator 114 determines whether the data structures can be optimized by using generated machine code. In one embodiment, machine code generator 114 determines, by heuristics, whether the data structures can be optimized with generated machine code based on the represented operation. For example, if the data structure represents an arithmetic expression, then machine code optimization is performed. In another example, if the data structure represents a “MOVE” operation, then generating machine code can optimize the structure. In another embodiment, machine code generator 114 may determine that the data structures can be optimized by using generated machine code if the operation is going to be repeated several times per query. If machine code generator 114 determines that the data structures can be optimized by using generated machine code, machine code generator 114 generates, or builds, the machine code and all the related structures needed for a query access path, including a structure for the operation “process machine code”. Machine code generator 114 is depicted and described in further detail with respect to FIG. 2.

RDBMS 110 includes runtime execution processor 116. Runtime execution processor 116 is a component of the RDBMS that reviews and interprets an access path of a query. Runtime execution processor 116 interprets the data structures and converts the data structures into executable instructions.

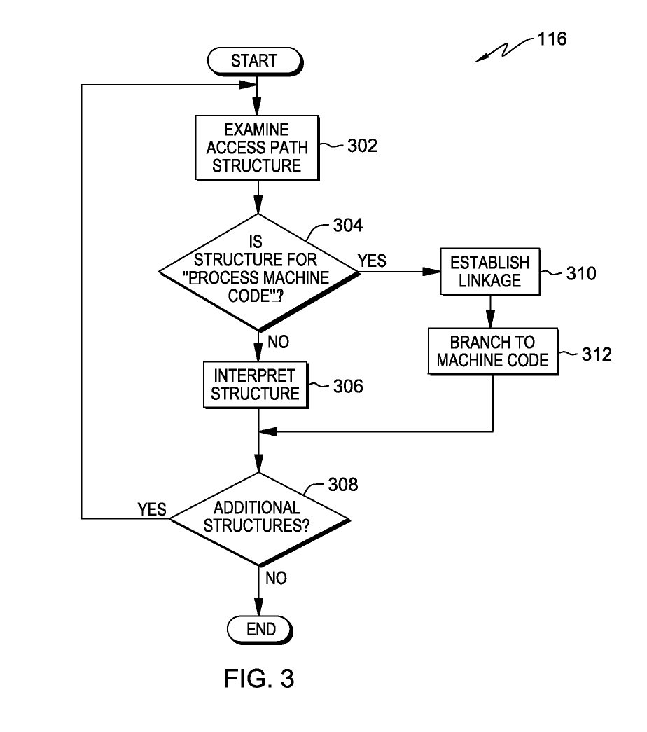

Runtime execution processor 116 includes generated code processor 118. At execution time, generated code processor 118 executes, or processes, the machine code and related structures that were generated by machine code generator 114. Generated code processor 118 is depicted and described in further detail with respect to FIG. 3.

Database 120 resides on server computer 108. A database is an organized collection of data. Typically a database used by a RDBMS is organized into tables with data being recognized by a row and/or a column location. Database 120 stores the data that RDBMS 110 accesses and manages.

FIG. 2 is a flowchart depicting operational steps of machine code generator 114, in relational database management system (RDBMS) 110 residing on server computer 108 within the data processing environment of FIG. 1, in accordance with an embodiment of the present invention.

Machine code generator 114 constructs a data structure for an access path operation (step 202). During prepare or bind time, SQL optimizer 112 determines the best access path for the given SQL statement. A data structure is a representation of an operation of the access path. For example, the data structure called “Mult” represents the operation of multiplying two numbers together. A data structure may have many fields within it. For example, the data structure called “Move”, for moving data from one buffer to another, may have the following fields:

structure ID
structure eye-catcher
address of source
address of target
length of source
length of target
padding byte
data type of source
data type of target
address of next structure

Interpreting a data structure may consist of many steps. For example, interpreting a “Move” data structure may consist of steps for: examining the data type of the operands, examining the length of the operands, examining whether the source operand is NULL or not, then generating the appropriate move instruction.

Machine code generator 114 determines whether machine code optimization can be used in the construction of the particular data structure (decision block 204). Database statements expressed in SQL are typically received and then interpreted by a runtime execution processor, such as runtime execution processor 116, instead of being compiled ahead of time in a build computer that generates machine code of a RDBMS. During interpretation, runtime execution processor 116 in RDBMS 110, executing in server computer 108, receives an access path that represents an SQL statement, and processes (interprets) the access path at database run time. The interpretation of an access path by runtime execution processor 116 incurs overhead. When the access path is converted to a representation that can be processed by runtime execution processor 116, machine code generator 114 determines whether a given access path operation, or a portion of the operation, can and should be processed via generated machine code. If not, the access path operation is interpreted by runtime execution processor 116. In that way, machine code generator 114 determines whether using machine code optimization can improve the efficiency of the code execution. As discussed previously, in one embodiment, machine code generator 114 determines, via heuristics, whether using machine code optimization can improve the efficiency of the execution. Machine code generator 114 determines whether the complexity of a given operation is suitable for generating machine code. Some operations, for example fetching data from a disk, are complex because they require a large amount of code or processing time or both. For those types of operations, generating machine code is not efficient because the coding is prone to error and difficult to service. Other operations, for example arithmetic expressions, are simple enough that generated machine code provides an efficiency improvement.

In another embodiment, a software developer creates a set of operations which, when recognized by machine code generator 114, are good candidates for optimization with generated machine code. For example, a MOVE operation is used in a significant number of queries, therefore a software developer may prioritize the MOVE operation as one that should always be optimized. In another embodiment, a software developer sets a limit for the lines of code in an operation for which machine code is generated. For example, a software developer may set a limit at 100 lines of code, such that if an operation will require more than 100 lines of code, that operation is not a candidate for optimization.

If machine code optimization can not be used (no branch, decision block 204), machine code generator 114 continues access path construction by constructing a data structure for interpretation by runtime execution processor 116 (step 206). If machine code optimization can be used (yes branch, decision block 204), machine code generator 114 generates machine code for the operation (step 210). In addition to generating machine code for the operation, machine code generator 114 can also generate a separate data structure that consists of a list of all reference addresses that are used by the generated machine code. Existing code can handle address relocation for addresses within a data structure, so no new relocation code is needed. In another embodiment, machine code generator 114 may also generate a structure to represent the operation of the “process machine code” step in the access path. In yet another embodiment, machine code generator 114 may group and combine the generated machine code for several operations that are performed in a sequence, minimizing the number of “process machine code” steps that have to be interpreted by runtime execution processor 116.

Machine code generator 114 determines if the operation can be performed with only machine code (decision block 212). Some database operations can not be easily optimized into generated machine code in their entirety, due to either complexity or limited availability of development resources. For example, machine code optimization may not be possible for an entire join operation; therefore, some aspects of the operation may be implemented in machine code that can be compiled, and other aspects may be implemented via data structures that are interpreted by runtime execution processor 116. If machine code generator 114 determines that the operation can not be performed with only machine code (no branch, decision block 212), machine code generator 114 generates helper structures (step 214). Helper structures allow operation optimization on a level more granular than by using machine code alone. Helper structures are useful when the operation to be optimized is too complex to be expressed by only generated machine code. Generating machine code for a complex operation is error prone and time consuming. However, a complex operation can be optimized on a step-wise level, or other sub-component of the operation, by using a combination of generated machine code and helper structures. The helper structures are used to process the complex steps of the operation, while generated machine code is used to process the simpler logic. For example, an operation to join two tables consists of several steps, such as step 1, step 2, step 3, step 4, and step 5. Step 2 and step 4 are complicated steps, while step 1, step 3, and step 5 are simple steps. The join operation can be optimized by building helper structures for steps 2 and 4, while generating machine code for steps 1, 3, and 5. The ability to interpose generated machine code with helper structures allows for efficient optimization of complex operations that may not be readily optimized in their entirety with only generated machine code.

In one embodiment, the machine code generator 114 generates fragments of machine code mixed with branches to runtime execution processor 116 which can interpret the data structures that are not optimized into machine code. The machine code then includes instructions to execute some machine code, and then load the address of a set of helper structures into a register and branch to runtime execution processor 116. Runtime execution processor 116 processes the helper structure and returns to the next instruction after the branch. The helper structures are structures with which runtime execution processor 116 is already familiar, allowing reuse of existing code. This will be discussed in more detail with reference to FIG. 3.

Subsequent to generating helper structures or determining that the operation can be performed with only machine code, machine code generator 114 determines whether the generated machine code can be combined with generated code for previous operations (decision block 216). If some operations are repetitive, reusing previously generated machine code may improve the efficiency of the access path. If the generated machine code can be combined with generated code for previous operations (yes branch, decision block 216), machine code generator 114 appends the generated machine code to existing data structures (step 220). If the generated machine code can not be combined with generated code for previous operations (no branch, decision block 216), machine code generator 114 constructs a new data structure representing the generated machine code (step 218).

Subsequent to constructing a new data structure, either with or without machine code optimization, or subsequent to appending machine code to an existing data structure, machine code generator 114 determines whether additional operations are required for the access path (decision block 208). If additional operations are required (yes branch, decision block 208), machine code generator 114 returns to step 202 to construct an additional data structure. If additional operations are not required (no branch, decision block 208), machine code generator 114 ends execution.

FIG. 3 is a flowchart depicting operational steps of runtime execution processor 116, in relational database management system 110 within the data processing environment of FIG. 1, in accordance with an embodiment of the present invention.

Runtime execution processor 116 examines an access path data structure (step 302). During execution time, runtime execution processor 116 examines a particular field of each data structure in the access path for determination of interpretation instructions.

Runtime execution processor 116 determines whether the data structure is for the operation of “process machine code” (decision block 304). If the data structure is not for the operation of “process machine code” (no branch, decision block 304), runtime execution processor 116 interprets the data structure (step 306).

If the data structure is for the operation of “process machine code” (yes branch, decision block 304), runtime execution processor 116 establishes a linkage to the generated machine code (step 310). Runtime execution processor 116 is an interpreter, not a compiler. Therefore, in order to process machine code, runtime execution processor 116 invokes generated code processor 118 logic. In one embodiment, generated code processor 118 ensures the expected linkage to the generated machine code by ensuring the designated register points to the information expected by the machine code logic.

Subsequent to establishing the linkage to the generated machine code via generated code processor 118, runtime execution processor 116 invokes generated code processor 118 to branch to the machine code logic (step 312). Branching to the machine code logic allows the machine code instructions to be executed, and control is then returned to generated code processor 118. In the example discussed above, where a join operation includes two complicated steps (steps 2 and 4) and three simple steps (steps 1, 3 and 5), runtime execution processor 116 branches to generated code processor 118 to execute step 1 followed by executing instructions for loading a helper structure for step 2. Then generated code processor 118 branches back to runtime execution processor 116 to execute step 2. Runtime execution processor 116 interprets the helper structure for step 2, and then branches back to generated code processor 118 to execute instructions for step 3 and for loading a helper structure for step 4. Generated code processor 118 branches back to runtime execution processor 116, and runtime execution processor 116 interprets the helper structure for step 4. Finally, runtime execution processor 116 branches back to generated code processor 118 for execution of instructions for step 5. Branching to machine code basically consists of two steps: 1) load address of the control block into a register, and 2) load address of the start of the machine code and execute branch instruction. Machine code is constructed such that it uses the corresponding register to access the control block. The control block is a data structure that contains information used by the machine code.

Subsequent to either runtime execution processor 116 interpreting an access path structure or generated code processor 118 branching to machine code, runtime execution processor 116 determines whether there are additional structures in the access path to interpret (decision block 308). If there are additional structures in the access path to interpret (yes branch, decision block 308), runtime execution processor 116 returns to step 302 and reviews the next structure. If there are no additional structures in the access path to interpret (no branch, decision block 308), runtime execution processor 116 ends execution.

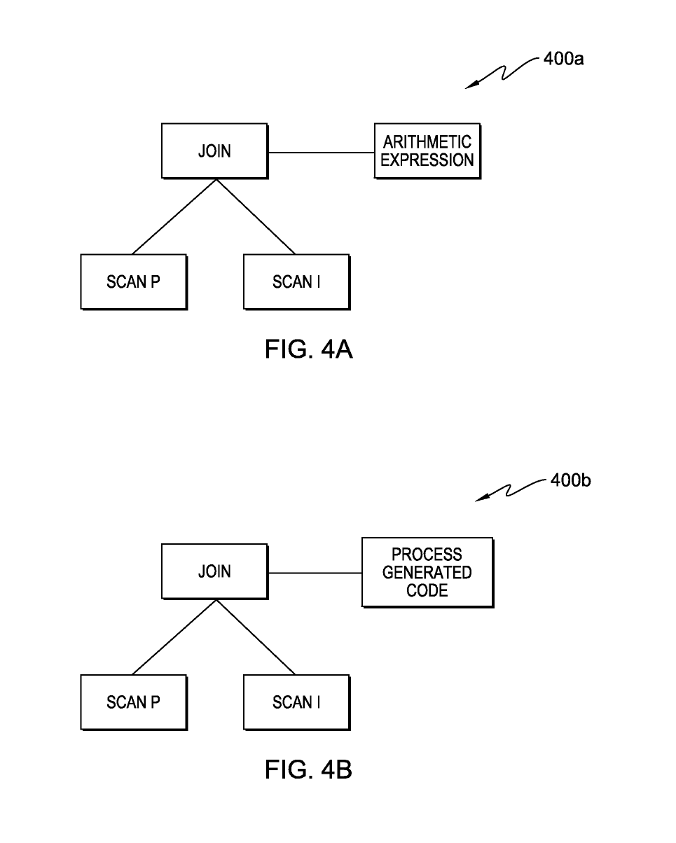

FIG. 4A is a depiction of access path portion 400a for an example SQL statement, in accordance with an embodiment of the present invention. In this example, the access path of the SQL statement takes the following form:

SELECT (P.PRICE − P.PRICE * P.DISCOUNT) AS SALE
FROM PRODUCT P, INVENTORY I
WHERE P.DISCOUNT > 0
AND P.ID = I.PID
AND I.COUNT > ?

As will be appreciated by one skilled in the art, the access path operations for the given SQL statement include: joining the tables called “PRODUCT” and “INVENTORY” using the nested loop join method, access table “PRODUCT” using the table-scan method, access table “INVENTORY” using the index-scan method, and apply the arithmetic expression “PRICE−PRICE*DISCOUNT” on each row after the join operation. Access path portion 400a is a high level representation of a relevant portion of the access path discussed above. Each block in access path portion 400a represents several data structures required to execute the operation. For example, the block labeled “ARITH EXPR” represents the data structures required to execute the arithmetic expression “PRICE−PRICE*DISCOUNT”. This operation includes the multiplication of two numbers together and subtraction.

FIG. 4B is a depiction of access path portion 400b for the example SQL statement described with respect to FIG. 4A that utilizes a generated code processor, previously presented in FIG. 1 as generated code processor 118, in accordance with an embodiment of the present invention. In this embodiment, the structures that would have been interpreted by runtime execution processor 116 for the arithmetic expression are replaced with a structure that processes machine code generated by machine code generator 114, and therefore are processed by generated code processor 118 instead of being interpreted by runtime execution processor 116. Generated code processor 118 contains pointers to machine code, data addresses, work area, and helper structures. By processing generated machine code for some of the operations in the access path instead of interpreting all of the operations, the access path is optimized. Any part of the access path may be improved by replacing a set of related structures with the process generated code structure.

FIG. 5 depicts a block diagram of components of server computer 108 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Server computer 108 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications, and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

SQL optimizer 112, including machine code generator 114, runtime execution processor 116, including generated code processor 118, and database 120 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of client computing device 104 and server computer 108. In these examples, communications unit 510 includes one or more network interface cards. Communications unit 510 may provide communications through the use of either or both physical and wireless communications links. SQL optimizer 112, including machine code generator 114, runtime execution processor 116, including generated code processor 118, and database 120 may be downloaded to persistent storage 508 through communications unit 510.

I/O interface(s) 512 allows for input and output of data with other devices that may be connected to server computer 108. For example, I/O interface(s) 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., SQL optimizer 112, including machine code generator 114, runtime execution processor 116, including generated code processor 118, and database 120, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for optimizing query processing within a relational database management environment, the method comprising:
constructing, by one or more computer processors, a first data structure for an access path operation, wherein the first data structure is an interpretable data structure;
determining, by the one or more computer processors, whether the first data structure can be optimized with machine code; and
responsive to determining the first data structure can be optimized with machine code, generating, by the one or more computer processors, machine code to perform at least one operation of the first data structure.

2. The method of claim 1, further comprising constructing, by the one or more computer processors, a second data structure including at least the generated machine code to perform the operation of the first data structure.

3. The method of claim 1, wherein determining the first data structure can be optimized with generated machine code further comprises:
determining, by the one or more computer processors, a type of operation to be performed by the first data structure;
determining, by the one or more computer processors, development resources available within the relational database management environment; and
determining, by the one or more computer processors, based, at least in part on, the type of operation to be performed and the development resources available, the access path operation is one that can be performed with generated machine code.

4. The method of claim 1, further comprising, responsive to determining the first data structure can not be optimized with machine code, continuing, by the one or more computer processors, access path construction with one or more interpretable data structures.

5. The method of claim 1, further comprising:
determining, by the one or more computer processors, the first data structure for the access path operation can not be performed by generated machine code alone;
generating, by the one or more computer processors, at least one helper data structure; and
constructing, by the one or more computer processors, a second data structure to perform the operation of the first data structure by interposing the generated machine code with the at least one helper data structure.

6. The method of claim 5, wherein a helper data structure includes at least one interpretable data structure capable of performing at least one complex portion of the first data structure for the access path operation.

7. The method of claim 1, further comprising:
generating, by the one or more computer processors, machine code for an additional data structure;
determining, by the one or more computer processors, the generated machine code for the first data structure can be combined with the generated machine code for the additional data structure; and
appending, by the one or more computer processors, the generated machine code of the first data structure to the generated machine code of the additional data structure.

8. A computer program product for optimizing query processing within a relational database management environment, the computer program product comprising:
one or more computer-readable storage media and program instructions stored on the one or more computer-readable storage media, the program instructions comprising:
program instructions to construct a first data structure for an access path operation, wherein the first data structure is an interpretable data structure;
program instructions to determine whether the first data structure can be optimized with machine code; and
responsive to determining the first data structure can be optimized with machine code, program instructions to generate machine code to perform at least one operation of the first data structure.

9. The computer program product of claim 8, further comprising program instructions to construct a second data structure including at least the generated machine code to perform the operation of the first data structure.

10. The computer program product of claim 8, further comprising:
program instructions to determine, by the one or more computer processors, a type of operation to be performed by the first data structure;
program instructions to determine, by the one or more computer processors, development resources available within the relational database management environment; and
program instructions to determine, by the one or more computer processors, based, at least in part on, the type of operation to be performed and the development resources available, the access path operation is one that can be performed with generated machine code.

11. The computer program product of claim 8, further comprising, responsive to determining the first data structure can not be optimized with machine code, program instructions to continue access path construction with one or more interpretable data structures.

12. The computer program product of claim 8, further comprising:
program instructions to determine the first data structure for the access path operation can not be performed by generated machine code alone;
program instructions to generate at least one helper data structure; and
program instructions to construct a second data structure to perform the operation of the first data structure by interposing the generated machine code with the at least one helper data structure.

13. The computer program product of claim 12, wherein a helper data structure includes at least one interpretable data structure capable of performing at least one complex portion of the first data structure for the access path operation.

14. The computer program product of claim 8, further comprising:
program instructions to generate machine code for an additional data structure;
program instructions to determine the generated machine code for the first data structure can be combined with the generated machine code for the additional data structure; and
program instructions to append the generated machine code of the first data structure to the generated machine code of the additional data structure.

15. A computer system for optimizing query processing within a relational database management environment, the computer system comprising:
one or more computer processors;
one or more computer-readable storage media;
program instructions stored on the computer-readable storage media for execution by at least one of the one or more processors, the program instructions comprising:
program instructions to construct a first data structure for an access path operation, wherein the first data structure is an interpretable data structure;
program instructions to determine whether the first data structure can be optimized with machine code; and
responsive to determining the first data structure can be optimized with machine code, program instructions to generate machine code to perform at least one operation of the first data structure.

16. The computer system of claim 15, further comprising program instructions to construct a second data structure including at least the generated machine code to perform the operation of the first data structure.

17. The computer system of claim 15, further comprising:
program instructions to determine, by the one or more computer processors, a type of operation to be performed by the first data structure;
program instructions to determine, by the one or more computer processors, development resources available within the relational database management environment; and
program instructions to determine, by the one or more computer processors, based, at least in part on, the type of operation to be performed and the development resources available, the access path operation is one that can be performed with generated machine code.

18. The computer system of claim 15, further comprising, responsive to determining the first data structure can not be optimized with machine code, program instructions to continue access path construction with one or more interpretable data structures.

19. The computer system of claim 15, further comprising:
program instructions to determine the first data structure for the access path operation can not be performed by generated machine code alone;
program instructions to generate at least one helper data structure; and
program instructions to construct a second data structure to perform the operation of the first data structure by interposing the generated machine code with the at least one helper data structure.

20. The computer system of claim 15, further comprising:
program instructions to generate machine code for an additional data structure;
program instructions to determine the generated machine code for the first data structure can be combined with the generated machine code for the additional data structure; and
program instructions to append the generated machine code of the first data structure to the generated machine code of the additional data structure.
